(19) United States
(12) Patent Application Publication
(10) Pub. No.: US 2013/0097697 A1
(43) Pub. Date: Apr. 18, 2013

(54) Security Primitives Employing Hard Artificial Intelligence Problems

(71) Applicants: Bin Benjamin Zhu, Edina, MN (US); Guanbo Bao, Beijing (CN); Maowei Yang, Chengdu (CN); Ning Xu, Beijing (CN)

(72) Inventors: Bin Benjamin Zhu, Edina, MN (US); Guanbo Bao, Beijing (CN); Maowei Yang, Chengdu (CN); Ning Xu, Beijing (CN)

(73) Assignee: Microsoft Corporation, Redmond, WA (US)

(21) Appl. No.: 13/273,841

(22) Filed: Oct. 14, 2011

(51) Int. Cl. G06F 21/00

(52) U.S. Cl. 726/18

(57) ABSTRACT

A security module generates a random image having a plurality of password-element indicators therein. The random image is provided to a user. The user selects portions of the random image. The security module determines whether the selected portions of the random image correspond to a password for the user. The security module grants access if the selected portions of the random image correspond to the user's password. However, if the selected portions of the random image do not correspond to the user's password, the security module may generate another random image having a plurality of password-element indicators therein, wherein each of the random images are computationally de-correlated.

### BACKGROUND

It is a fundamental method in computer security to create cryptographic primitives based on hard mathematical problems that are computationally intractable. For example, the problem of integer factorization is fundamental to RSA (which stands for Rivest, Shamir and Adleman who first publicly described it) public-key cryptosystem and Rabin encryption. The discrete logarithm problem is fundamental to ElGamal encryption, Diffie-Hellman key exchange, Digital Signature Algorithm, elliptic curve cryptography and so on.

Using hard artificial intelligence problems for security is an exciting new paradigm. Under this new paradigm, the most notable primitive invented is CAPTCHA, which is now a standard Internet security technique where CAPTCHA stands for “Completely Automated Public Turing test to tell Computers and Humans Apart”. CAPTCHA distinguishes between humans and computers by presenting a challenge, i.e., a puzzle, beyond the capability of computers but easy for humans. Visual CAPTCHAs can be classified into text CAPTCHAs and image recognition CAPTCHAs depending on what to recognized, characters or visual objects and images. CAPTCHA has been largely deployed to protect online email services from being abused by bots. Another notable application is in a class of security protocols, herein referred to as CAPTCHA-based Password Authentication (CPA) protocols, in which CAPTCHA and password are combined in a protocol to defend against online dictionary attacks on passwords.

Another notable invention is POSH (Puzzle Only Solvable by Human), which is similar to CAPTCHA but the answers are required to be consistent only for the same person. Different people may provide different answers to the same puzzle. POSH was proposed to mitigate offline dictionary attack on passwords or password-derived keys.

Pixels in an image are not equal. Some spots are salient and informational, and thus more helpful in memorizing their locations than others. Hotspots and security of click-based graphical passwords have been studied. In general, selecting hotspots in a password helps memorization of the password but makes the password vulnerable to dictionary attacks wherein hotspots are collected to guess passwords. A trial and error procedure is then applied to find out the actual passwords. Selecting more randomly distributed click-points produces a stronger password but may lead to difficulty to remember it. This conflict between password memorization and security presents a fundamental problem in designing a graphical password system. Existing designs of click-based graphical systems have tried to strike a balance between the two conflict requirements.

Cued Click Points (CCP) enlarges the search space by requiring a user to click a sequence of images in entering a password instead of a single image commonly used graphical password systems. Persuasive Cued Click Points (PCCP) extends CCP by requiring a user to select a point inside a randomly positioned viewport in creating a password, resulting in more randomly distributed click-points. These schemes have mitigated the hotspot problem but still focused on striking a balance between password memorization and security. They may still be vulnerable to dictionary attacks. For example, the click-point selected from a randomly positioned viewport in PCCP may still be a salient structural point in the image in order to remember its location. A large set including all these salient structural points, i.e., “extended” hotspots, can be collected by using image processing techniques and from the click-points used by people to build a dictionary, which, albeit much larger than that for other click-based graphical password schemes, can then be used to launch dictionary attacks to find weak passwords in PCCP.

### SUMMARY

This disclosure describes a new security primitive based on hard artificial intelligence problems, namely, a family of graphical password systems. In some embodiments, the graphical password systems may be built on top of CAPTCHA technology, and such a graphical password system may be referred to as CaRP (CAPTCHA as gRaphical Passwords) system.

A CaRP system employs a user selection-based graphical password scheme, where a user provides a sequence of selections, such as by clicking on and/or touching an image, and these selections are used to derive the user's password. However, images used in a CaRP system may be automatically generated by a CAPTCHA-based generator. That is, the image upon which a user makes selections in CaRP may be a CAPTCHA challenge, and in some embodiments, a new CaRP image is generated and/or provided to the user for every login attempt.

CaRP employs an approach very different from existing click-based graphical systems. Goals of CaRP approach include: 1) de-correlation of hotspots between different login attempts; and 2) disabling computers from correctly inputting a graphical password or recovering the password from a user's selections. The CaRP approach allows using hotspots in a password for easy memorization but, in some embodiments, varies the image for each login attempt, and furthermore, the hotspots in the image of one login attempt are made computationally uncorrelated to the hotspots in the image of another login attempt to thwart dictionary attacks. However, the CaRP approach retains some invariants that humans can use as a password but cannot be computed by a computer. This constraint is similar to that of CAPTCHA. By generating images satisfying this constraint, these images can also be used to distinguish between humans and computers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment for a CaRP system.

FIG. 2 is a schematic diagram of a second illustrative environment for a CaRP system.

FIG. 3 is a schematic diagram of a third illustrative environment for a CaRP system.

FIG. 4 is a block diagram of illustrative relationships in a CaRP environment.

FIGS. 5A and 5B are block diagrams of illustrative passwords in a CaRP environment.

FIG. 6 is a block diagram of an illustrative user-interface displaying a primitive domain.

FIG. 7 is flow diagram of an illustrative process for providing a user with a password in a CaRP system.

FIG. 8 is flow diagram of an illustrative process for implementing CaRP with internet protocols.

FIG. 9 is a block diagram of another illustrative display device displaying a CaRP image.

FIG. 10 is a block diagram of a primitive domain that may be employed in a CaRP environment.

FIG. 11 is a flow diagram of an illustrative procedure for generating a CaRP ClassObjs Image.

FIGS. 12A-12C are block diagrams of an illustrative display displaying a CaRP ClassObjs image.

FIGS. 13A and 13B are diagrams of illustrative point-based fine point CaRP (FP-CaRP) potential password elements.

FIG. 14 is a block diagram of an illustrative computing device that may be deployed in the environment shown in FIGS. 1-3.

### DETAILED DESCRIPTION

### Overview

Conceptually, a CaRP (CAPTCHA as gRaphical Passwords) maybe seem uncomplicated but it may be generic, and it may have multiple instantiations—a CaRP system can be built on top of either a text CAPTCHA or an image recognition CAPTCHA. For example, one of such instantiations is a text CaRP, where each image is a text CAPTCHA challenge with printable symbols displayed in a distorted form with sophisticated connections. In this instance, the user remembers the user's password as a text password. However, the user enters the password in a CaRP system by selecting the right character sequence on the image. The user may select characters by, among other things, clicking on characters with a mouse and or touching a touch sensitive input device.

CaRP thwarts automated attacks by preventing computers from correctly inputting a password or recovering the password from a user's selections. Furthermore, CaRP images used in different login attempts are computationally uncorrelated, which therefore effectively removes vulnerability caused by image hotspots, a problem inherent in many selection/click-based graphical password schemes that often leads to weak password choices. In particular, CaRP offers protection against the following attacks:
1. Online dictionary attacks on passwords: These have been a longstanding and major security threat for various online services. This threat is now widespread and considered as a top cyber security risk as more and more online services use web-based password authentication.
2. Relay attacks on CAPTCHAs: These have been an increasing threat to online applications defended by CAPTCHAs. For example, a computer worm, Koobface, was used to break CAPTCHA security at FACEBOOK in order to register new FACEBOOK accounts. In a relay attack, CAPTCHA challenges are relayed to humans, the humans answer the CAPTCHA challenges, and the humans' answers are returned.

CaRP can also mitigate spyware threats and can be applied to dramatically reduce spamming emails sent from an online email service provider.

CAPTCHA-based Password Authentication (CPA) protocols bind a CAPTCHA and a password together in an authentication process. In these protocols, the CAPTCHA and the password are still two separate entities. However, in some embodiments, the intrinsic combination of the CAPTCHA and the password in CaRP creates a new security primitive. In some embodiments, CaRP may be both a CAPTCHA and a password authentication system, offering not just defense against online dictionary attack, but also additional advantages such as being robust to relay attacks on CAPTCHAs that CPA protocols, using CAPTCHAs to defend against online dictionary attacks, are vulnerable to.

In some embodiments, CaRP may be both a CAPTCHA and a graphical password system. In some embodiments, CaRP may use a domain of potential password-elements, each potential password-element being an image of an object (e.g., characters, animals, manmade objects, mythical creatures, etc.) to generate, at each login attempt, a CAPTCHA image based on some or all of the potential password-elements. Each potential password-element in the domain may have different incarnations. For example, a potential password-element of a character “A” may be appear as Times New Roman, Arial, or other fonts; or an animal such as a dog may appear to be different breeds such as a poodle, a Saint Bernard, Australian Shepherd, Border Collie, etc. Object recognition is needed in CaRP. As with CAPTCHA, the difference between a human's capability and a computer's capability to recognize the objects in a CaRP image makes object recognition an easy task for humans but intractable for computers. CaRP thwarts dictionary attacks by preventing building a useful dictionary to attack and automated attacks by preventing computers from knowing how to correctly input a password or deducing the actual password even when the user's selections are known.

Among other things, a significant difference between CaRP and existing selection/click-based graphical password systems is that while hotspots still exist in each CaRP images, hotspots cannot be exploited to launch dictionary attacks against CaRP. Hotspots in different CaRP images are computationally uncorrelated. This de-correlation makes a dictionary built upon collected hotspots from previously used images useless in finding the hotspots in a new image used in a current login. Dictionary attacks are therefore thwarted. On the other hand, hotspots can be used to help memorize a password in CaRP, as discussed below. CaRP has thus fundamentally removed the conflict between password memorization and security that the existing graphical password systems try to strike a balance.

A password in CaRP is a sequence of visual object names or primitive elements, e.g., images of characters (same as conventional text password) for text-based CaRP. A dictionary attack on the sequence of visual object names or primitive elements cannot be successful since, given a trial sequence, a computer cannot correctly select/click the objects in the sequence on the CaRP image to input a password due to its inability to recognize the visual objects in the image—an attribute of CAPTCHA. Humans have to be employed to recognize the visual objects in each CaRP image for each login attempt. A human-based dictionary attack is significantly inefficient and usually costly since humans are much slower to complete one login attempt than are computers.

There are two major differences between a CaRP image and a CAPTCHA challenge image:
1. All the visual objects in the primitive domain may, or should, appear in a CaRP image but are not necessarily in a CAPTCHA challenge image. This allows a user to enter any possible password.
2. Visual objects in a CaRP image can be arranged randomly without any order. Visual objects in a CAPTCHA image, on the other hand, may be of certain order so that a user knows how to type in a proper order. For example, for a text-based CaRP image characters may be arranged anywhere on a 2D space but only from left to right for a text CAPTCHA challenge.

### Illustrative Environments

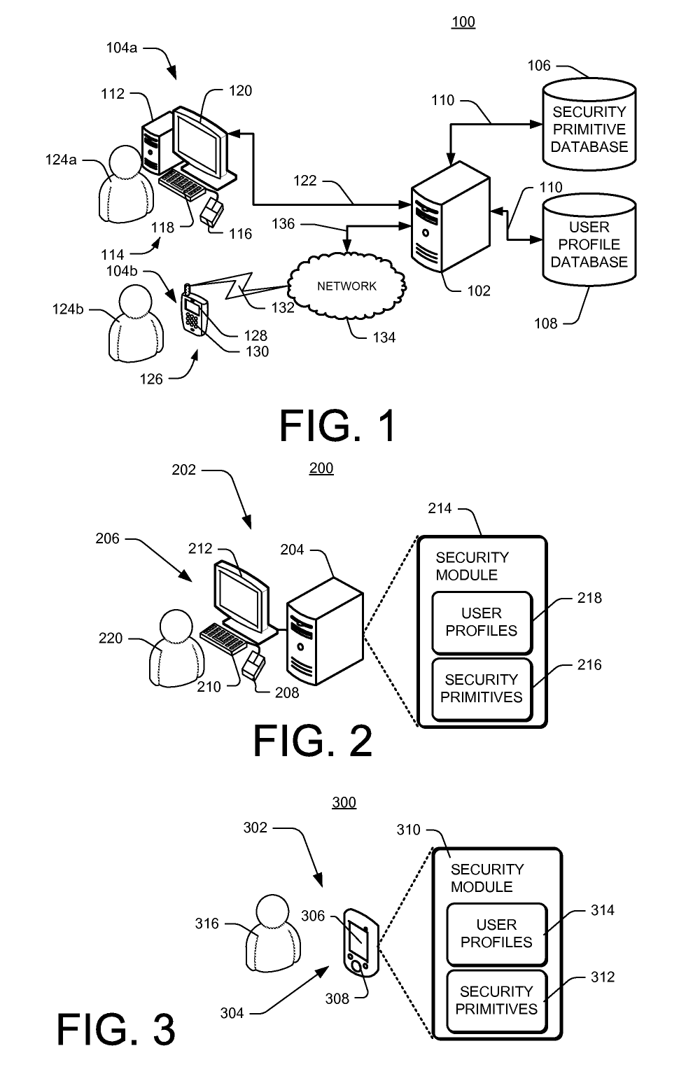

FIG. 1 is a schematic diagram of an illustrative environment 100 for employing CaRP. The environment 100 may include at least one security administrator 102, and one or more user devices, individually referenced as 104a and 104b and collectively referenced as 104.

The security administrator 102 may be a computing system such as a server, web server, desktop computer, laptop computer, or the like. The security administrator 102 is communicatively coupled to security primitive database 106 and to user profile database 108, via communication links 110. The security primitive database 106 may include, among other things, images that are used to generate log-in challenges that are displayed to users of the CaRP. The user profile database 108 may include, among other things, user identifications (user-ids) of users of the CaRP. The user profile database 108 may further include a respective password indicator for users of the CaRP in which a password indicator may indicate a password but is not a password. A non-limiting example of a password indicator is hash value H(P,s) of a user's password P with a salt s. The user profile database 108 may further include a respective password for users of the CaRP. The passwords may be encrypted for security purposes.

The user device 104a may be a desktop computing system having a tower 112 and user interface devices 114. The user interface devices 114 may include a mouse and/or a touchpad 116, a keyboard 118 and display device 120.

A user 124a uses the user device 104a to access the security administrator 102 via a wired or wireless communication link 122. Among other things, the security administrator 102 provides an image to the user device 104a for display on the display device 120. The user 124a uses the user interface devices 114 to select one or more regions or points of the image displayed on the display device 120. The user 124a may select a region of the images by, among other things, using the mouse and/or touchpad 116 and/or keyboard 118 to position a cursor over a point inside the region to select and to “click” upon the point. The user 124a may select a point by, among other things, using the mouse and/or touchpad 116 and/or keyboard 118 to position a cursor over the point to select and to “click” upon the point. The user device 104a collects the coordinates [(x1,y1), (x2, y2) . . . (xK, yK)] of the points that the user input to the interface devices 114, sends to the security administrator 102 information based at least on the points the user input. In one embodiment, the user device 104a sends the coordinates [(x1,y1), (x2, y2) . . . (xK, yK)] to the security administrator 102. This communication may be protected to ensure the security of the communicated messages. In another embodiment, the user device 104a may locate the points in a set a priori that are closest to and within a tolerable error of the selected coordinates [(x1,y1), (x2, y2) . . . (xK, yK)], and sends to the security administrator 102 information based at least partially on these located points. Based at least on the information received from the user device 104a, the security administrator 102 determines whether the user 124a selected regions or points corresponding to the user's password.

The user device 104b may be a portable user device such as, but not limited to, a cell phone, a smart phone, a tablet, a personal digital assistant, and may be a multifunction device. The user device 104b includes user-interface component 126. The user interface component 126 includes a display component 128, which may be a touch sensitive component, and may include keys 130.

A user 124b uses the user device 104b to access the security administrator 102. The user device 104b is in wireless communication, via wireless communication link 132, with a network 134, and a communications link 136 communicatively couples the network 134 to the security administrator 102.

Among other things, the security administrator 102 provides an image to the user device 104b for display on the display component 128. The user 104b uses the user interface component 126 to select one or more regions or points of the image displayed on the display component 128. The user 124b may select a region of the images by, among other things, using the keys 130 to position a cursor over a point inside the region to select and to “click” upon the point. Similarly, the user 124b may select a region of the image by, among other things, touching the display component 128 on a point within the region to select. The user 124b may select a point of the image in a similar manner. The user device 104b collects the coordinates [(x1,y1), (x2, y2) . . . (xK, yK)] of the points that the user input to the interface component 126, and sends to the security administrator 102 information based at least on the points the user input. In one embodiment, the user device 104b sends the coordinates [(x1,y1), (x2, y2) . . . (xK, yK)] to the security administrator 102. This communication may be protected to ensure the security of the communicated messages. In another embodiment, the user device 104b may locate the points in a set a priori that are closest to and within a tolerable error of the selected coordinates [(x1,y1), (x2, y2) . . . (xK, yK)], and sends to the security administrator 102 information based at least partially on these located points. Based at least on the information received from the user device 104b, and the security administrator 102 determines whether the user 124b selected regions or points corresponding to the user's password.

FIG. 2 is a schematic diagram of an illustrative environment 200 for employing CaRP. The environment 200 includes a computing system 202 such as a personal computer, desktop computer, laptop computer, server, web server, etc. The computing system 202 may include a tower 204 and user interface devices 206. The user interface devices 206 may include a mouse and/or a touchpad 208, a keyboard 210 and display device 212.

The computing system 202 includes a security module 214. The security module 214 includes security primitives 216 and user profiles 218. The security primitives 216 may include, among other things, images that are used to generate log-in challenges that are displayed to users of the CaRP. The user profiles 218 may include, among other things, user identifications (user-ids) of users of the CaRP. The user profiles 218 may further include a respective password indicator for users of the CaRP in which a password indicator may indicate a password but is not a password. A non-limiting example of a password indicator is hash value H(P,s) of a user's password P with a salt s. The user profiles 218 may further include a respective password for users of the CaRP. The passwords may be encrypted for security purposes.

A user 220 access the computing system 202 via the security module 214. Among other things, the security module 214 provides an image for display on the display device 212. The user 220 uses the user interface devices 206 to select one or more regions or points of the image displayed on the display device 212. The user 220 may select a region of the images by, among other things, using the mouse and/or touchpad 208 and/or keyboard 210 to position a cursor over a point inside the region to select and to “click” upon the point. Similarly, the user 220 may select a region of the images by, among other things, using the mouse and/or touchpad 208 and/or keyboard 210 to position a cursor over the point to select and to “click” upon the point.

The security module 214 determines whether the user 220 selected regions or points corresponding to the user's password based at least on the coordinates [(x1,y1), (x2, y2) . . . (xK, yK)] of the points that the user selected.

FIG. 3 is a schematic diagram of an illustrative environment 300 for employing CaRP. The environment 300 includes a portable user device 302 such as, but not limited to, a cell phone, a smart phone, a tablet, a personal digital assistant, and a multifunction device. The user device 302 includes user-interface component 304. The user interface component 304 includes a display component 306, which may be a touch sensitive component, and may include keys/buttons 308.

The user device 302 includes a security module 310. The security module 310 includes security primitives 312 and user profiles 314. The security primitives 312 may include, among other things, images that are used to generate log-in challenges that are displayed to users of the CaRP. The user profiles 314 may include, among other things, user identifications (user-ids) of users of the CaRP. The user profiles 314 may further include a respective password indicator for users of the CaRP in which a password indicator may indicate a password but is not a password. A non-limiting example of a password indicator is hash value H(P,s) of a user's password P with a salt s. The user profiles 314 may further include a respective password for users of the CaRP. The passwords may be encrypted for security purposes.

A user 316 accesses the user device 302 via the security module 310. Among other things, the security module 310 provides an image (not shown) for display on the display component 306. The user 316 uses the user interface component 304 to select one or more regions or points of the image displayed on the display component 306. The user 316 may select a region of the images by, among other things, using the keys/buttons 308 to position a cursor over a point inside the region to select and to “click” upon the point. The user 316 may select a point by, among other things, using the keys/buttons 308 to position a cursor over the point to select and to “click” upon the point. Similarly, the user 316 may select regions or points of the image by, among other things, touching the display component 306.

The security module 310 determines whether the user 316 selected regions or points corresponding to the user's password based at least on the coordinates [(x1,y1), (x2, y2) . . . (xK, yK)] of the points that the user selected.

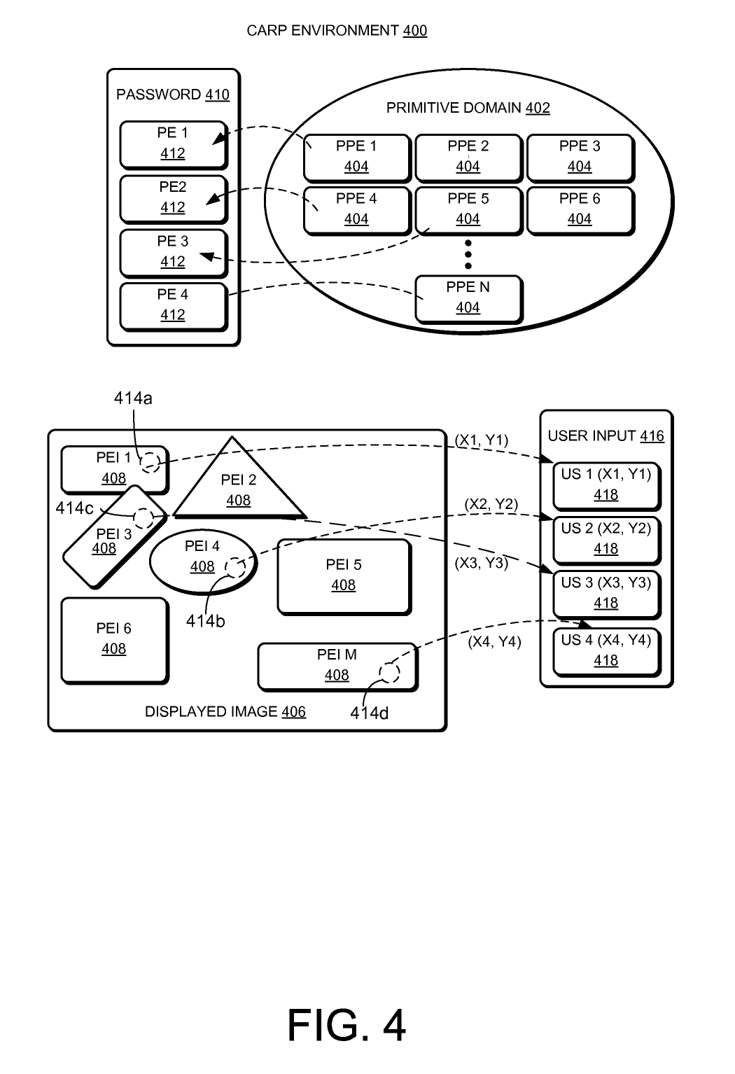

FIG. 4 is a block diagram of relationships in a CaRP environment 400. Referring to FIGS. 1-3, the security administrator 102 or the security module 214/310 generates a CaRP image and provides the CaRP image to a user-device such as user-devices 104a, 104b, 302 or computing system 202. The CaRP image is based on images in a primitive domain 402. The primitive domain 402 includes N potential password-elements (PPEs) (PPE1-PPE N) 404. Collectively, the potential password-elements 404 span all possible passwords in the CaRP environment 400.

A displayed image 406 is provided to the user via the user-device. The displayed image 406 includes a number of password-element indicators (PEI 1-PEI M) 408. Each password-element indicator 408 corresponds to one of the potential password-elements 404. For example, PEI 1 corresponds to PPE 1, PEI 2 corresponds to PPE 2, and so on. In some embodiments, the number M of password-element indicators 408 may be equal to the number N of potential password-elements 404. However, in other embodiments, the number M of password-element indicators 408 may be less/greater than the number N of potential password-elements 404. For example, in one embodiment, two password-element indicators in the displayed image 406 may be of the same potential password-elements but are visually different in order to make it more difficult for computers to recognize the password-elements in the displayed image 406. This may lead to M>N. In another embodiment, an a priori subset of the potential password-elements is used in a password, and the password-element indicators corresponding to the subset of PPEs appear in the displayed image 406. This may lead to M<N. Typically, each password-element indicator 408 is displayed to be visually different from its corresponding potential password-element 404, and two password-element indicators 408 corresponding to the same potential password-element 404 and displayed in the same displayed image 406 or two different displayed images 406 are displayed to be visually different. The visual difference may be due to different incarnations of the potential password-element 404 and/or through operations, joint or independent, such as, but not limited to, uniform and/or non-uniform scaling, rotation, changing of point-of-view, deformations, transformations and/or CAPTCHA operations.

A user's password 410 may be a sequence of a number (K) password-elements (PE) 412. For the sake of clarity, password 410 is shown as consisting of four password elements PE 1-PE 4. However, other passwords may include fewer, the same, or a greater number of password elements 412. Each one of the password-elements 412 corresponds to one of the potential password-elements 404. For example, PE 1 corresponds to PPE1, PE 2 corresponds to PPE 4, PE 3 corresponds to PPE 5 and PE 4 corresponds to PPE N.

The user selects points/regions, individually referenced as 414a-414d and collectively as 414, of the displayed image 406. User input 416 corresponding to the user's selected points/regions 414 is provided to or used to produce information to send to the security administrator 102 or the security module 214/310. The user input can be sent directly to security administrator 102 or the security module 214/310 (when a communication channel between the user-devices 104a, 104b, 302 or computing system 202, and the security administrator 102 or the security module 214/310 is secure) or is used to deduce information (such as in a challenge response authentication which is typically used when the communication channel is not secure) to send to the security administrator 102 or the security module 214/310. A challenge-response authentication protocol may be used to exchange information between two parties such that one party tries to convince the other party that he/she knows the password without actually sending the password.

The user input 416 is a sequence of K user selections (US) 418. For the sake of clarity, user input 416 is shown as consisting of four user selections US 1-US 4. However, other user inputs may include fewer, the same, or a greater number of user selections 418. Each user selection 418 provides a coordinate (X,Y) of a point corresponding to the user's selection. In some embodiments, a password-element indicator 408 may have a point of coordinate (X,Y) associated with it, and when the user selects the password-element indicator 408 the coordinate (X,Y) is provided as one of the user inputs 416. In some embodiments, there may be a set of selectable points/regions associated with the password-element indicators 408 displayed in the displayed image 406, and each selectable point/region 414 may have a coordinate, e.g., (Xa,Ya), associated with it, and when the user selects a point of coordinate (X,Y), the closest selectable point/region is located, and its coordinate, e.g., (Xa,Ya), is provided as one of the user selections 418. In some embodiments, the distance between the user-selected point of coordinate (X, Y), and the coordinate (Xa, Ya) of the closest selectable point/region should be within a tolerable error. In some embodiments, when the user selects a point/region 414 of the password-element indicator 408, the coordinate (X,Y) of the selected point is provided as one of the user selections 418.

The security administrator 102 or the security module 214/310 receives information based at least on the user input 416. In one embodiment, the received information is the user input 416. This is typically applied when the security administrator 102 or the security module 214/310 can receive the user input 416 in a secure manner such as via secure communication channel. In another embodiment, the received information may be different from the user input 416, but is based at least on the user input 416. Even when the information sent to the security administrator 102 or the security module 214/310 is known to adversaries, the user input still cannot be deduced. This is typically used when the communication channel to the security administrator 102 or the security module 214/310 is not secure. The user input 416 is a purported password, which may or may not be valid. Based at least on knowledge of the displayed image 406 and the received information, the security administrator 102 or the security module 214/310 determines if the user input 416 matches the password 410 or its password indicator (not shown) of the user, which may be stored in the user profile database 108 or user profiles 218/314.

In one embodiment, the security administrator 102 or the security module 214/310 receives the user input 416, and determines which password-element indicators 408 correspond to the sequence of user selections 418, and maps these password-element indicators 408 back to the corresponding potential password-elements 404. These corresponding potential password-elements 404 are considered purported password-elements, which may or may not correspond to the password-elements 412 of the password 410. The security administrator 102 or the security module 214/310 determines whether the purported password-elements correspond, in type and in sequence, to the actual the password-elements 412.

In another embodiment, security administrator 102 or the security module 214/310 derives the sequence of selected points/regions corresponding to the password 410 of the user stored in the user profile database 108 or user profiles 218/314, and compares with the received information to determine if the user input 416 matches the sequence derived from the password 410.

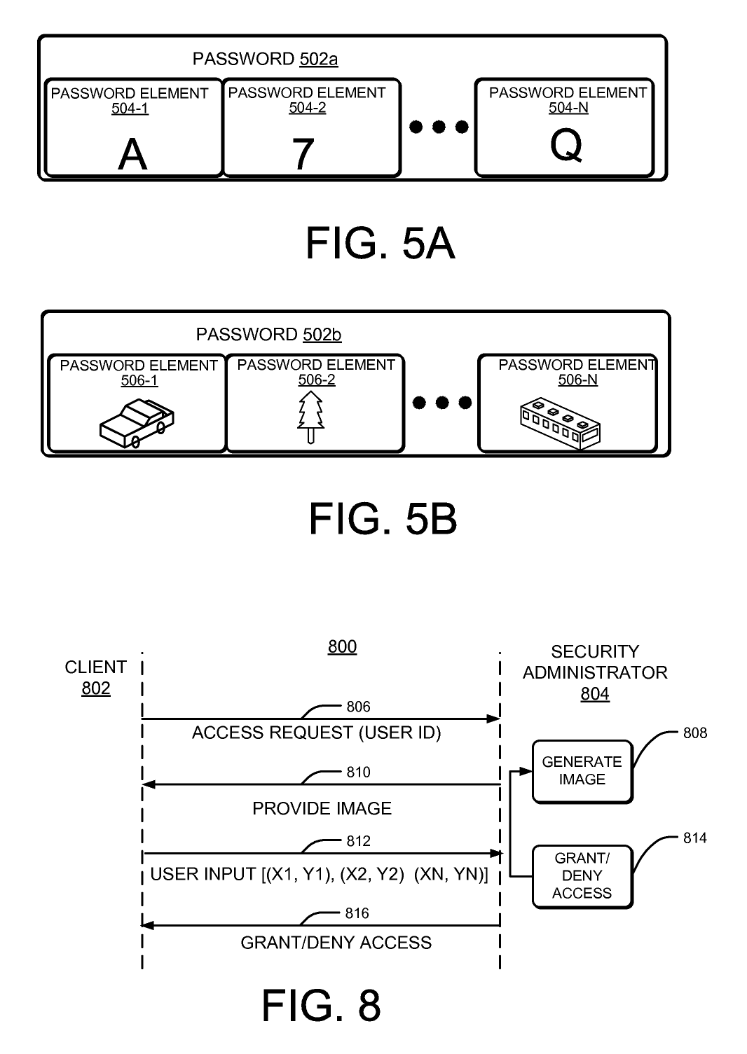

FIGS. 5A and 5B are block diagrams of passwords 502a and 502b, respectively. Each one of the passwords 502a and 502b is a sequence of a number of password-elements. Password 502a is comprised of password-elements 504-1 through 504-N, which are images of alphanumeric characters. An image having the password 502a therein will include images of the characters “A,” “7,” and “Q,” and all other password-elements between 504-1 and 504-N.

Password 502b is comprised of password-elements 506-1 through 506-N, which are images of objects such as a car, tree and building. An image having the password 502b therein will include images of the “car,” “tree,” and “building,” and all other password-elements between 506-1 and 506-N. As another example, a password may be comprised of a number of password-elements that are images of objects such as a dog, a cat, a tiger and/or other animals which are similar to one another. Images that are similar to one another may be used because humans may easily discern the differences between the images but computers have a hard time to differentiate one from another.

In some embodiments, a password may be comprised of multiple types of password-elements that may be a combination of images of different types of objects, for example, animals and alphanumeric characters.

### Creating a Password

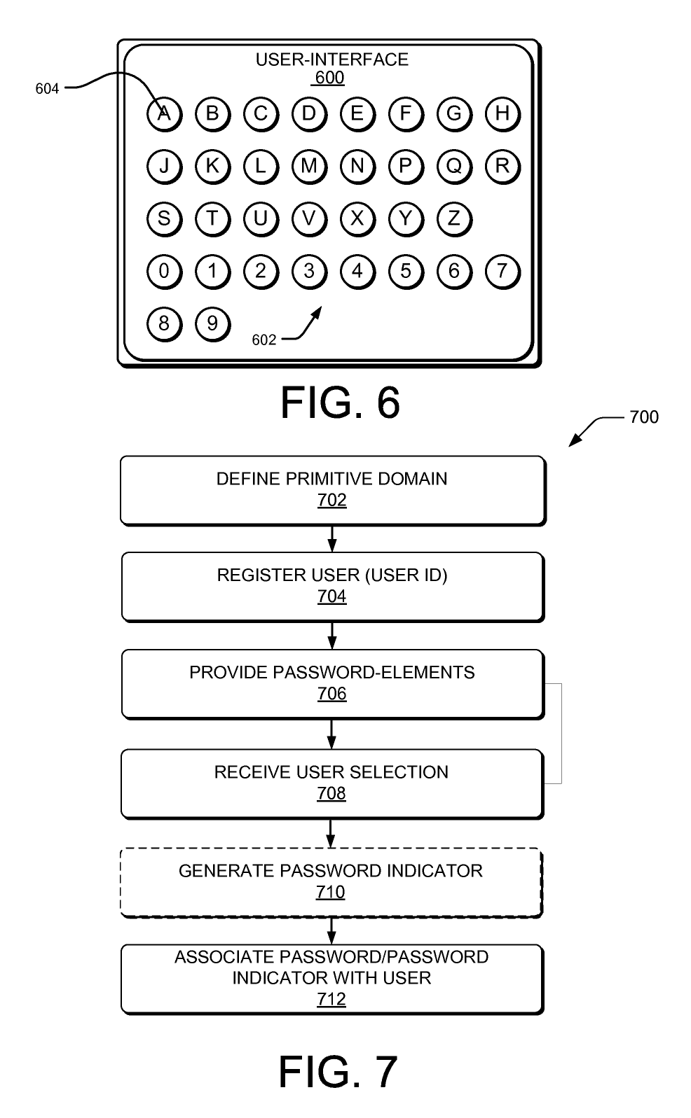

FIG. 6 is a block diagram of a user-interface 600 displaying a primitive domain 602. The user-interface 600 may be viewed on the user-devices 104a, 104b, 302 (see FIGS. 1 and 3) and the computing system 202 (see FIG. 2).

The primitive domain 602 includes multiple potential password-elements 604. The multiple potential password-elements 604 span the space of all possible passwords. Each one of the potential password-elements 604 is an image that can be selected as a password-element. In the illustrated embodiment of the primitive domain 602, the potential password-elements 604 are alphanumeric characters. Some common alphanumeric characters such as letters “I” (capital “i”) and “O” are omitted due to their visual similarities to numbers 1 and 0.

FIG. 7 is a flow diagram of a process 700 for providing a user with a password in a CaRP system. The process 700 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure shall be interpreted accordingly.

At 702, a primitive domain of potential password-elements is defined. Collectively, the potential password-elements span all possible passwords. The CaRP environment, such as the security primitive database 106 in FIG. 1 and security primitives 216 and 312 in FIGS. 2 and 3, may contain multiple incarnations for each potential password-element. For example, the CaRP environment may contain Times New Roman, Arial, or other fonts for a potential password-element of a character “A”; or a Saint Bernard, Australian Shepherd, Border Collie, etc. for a potential password-element of an animal dog. Different incarnations of a potential password-element introduce more variations in the generated CaRP images, making it harder for computers to recognize.

At 704, a user registers with the CaRP system. For example, referring to FIG. 1, user 124a may register with the security administrator 102. Similarly, referring to FIGS. 2/3, user 220/316 may register with the security module 214/310. Registration may include providing identifying information and creating/establishing/providing a user-id.

At 706, the user is provided with potential password-elements. The potential password-elements may be displayed on user-devices 104a, 104b, 302 (see FIGS. 1 and 3) and computing system 202 (see FIG. 2). In some embodiments, an entire primitive domain may be displayed at one time. In other embodiments, one or more of the potential password-elements of a primitive domain may be displayed at one time.

At 708, user input for selected potential password-elements is received. In some embodiments, the user may select, one-by-one, a number of potential password-elements, in which each selected potential password-element is then assigned to a corresponding one of the password-elements.

At 710, which in some embodiments may be optional, a password indicator may be generated. The password indicator may be indicative of the corresponding password and may be used for verifying that a purported password entered by a user is in fact a valid password. For example, a password indicator may be a hash value H(P,s) of a user's password P with a salt s.

At 712, the user's password and/or the generated password indicator is associated with the user. The password and/or the generated password indicator may be stored in the security primitive database 106 and/or security primitives 216/312.

CaRP for Web Applications

Security of user authentication in Web applications relies on two parts: Hypertext Transfer Protocol Secure (HTTPS) and HTTP Authentication.

HTTPS. The Transport Layer Security (TLS) or its predecessor, Secure Sockets Layer (SSL), provides server authentication, confidentiality, and integrity at the transport layer. It builds a secure communication channel between a client and a Web server.

HTTP Authentication. HTTP Authentication runs at the application layer to authenticate a client to a Web server. This is one protocol wherein CaRP may be used. Web applications almost exclusively adopt the HTTP Basic Access Authentication protocol for user authentication, wherein the client sends both userID and password, encoded with Base64 to the server for user authentication.

The CaRP schemes in some embodiments, such as CaRP for Web Application, may be implemented to work with the widely used HTTP Basic Authentication. Note that for both HTTP authentication protocols, TLS/SSL provides the communication security between a client and a Web server.

FIG. 8 is a flow diagram of an illustrative process 800 for implementing CaRP with internet protocols such as HTTP Basic Access Authentication. The process 800 involves acts implemented at a client 802 and a security administrator 804, which may be embodied in a web server. The security administrator 804 may store user-IDs and password indicators.

At 806, the security administrator 804 receives an access request from the client 802. The access request may, optionally, include the user's user-id.

At 808, the security administrator 804 generates a CaRP image. In some embodiments, the CaRP image includes all of the potential password-elements that make up the primitive domain 602. In other embodiments, the CaRP image includes less than all of the potential password-elements that make up the primitive domain 402, 602.

At 810, the security administrator 804 sends the CaRP image to the client 802. A user selects regions/points on the received image to enter the user's password. For example, the user may select characters “A”, “B”, “C”, “D”, “#”, “9”, “8”, and “7” sequentially on the CaRP image.

At 812, the coordinates [(x1,y1), (x2, y2) . . . (xK, yK)] of the selected points on the CaRP image are provided to the security administrator 804. In some embodiments, the user's user-ID is also provided, using the HTTP Basic Authentication, to the security administrator 804 with the coordinates [(x1,y1), (x2, y2) . . . (xK, yK)] of the selected points on the CaRP image.

At 814, the security administrator 804 determines whether to grant or deny access. The security administrator 804 may map the coordinates back on the CaRP image previously provided to the client 802, and recover a sequence of purported password-elements, P′, that the user selected on the CaRP image at the client 802. The security administrator 804 may then determine whether the sequence of purported password-elements, P′, correspond to the sequence of password-elements that make up the user's password. For example, the security administrator 804 may retrieve the salt s of the associated with the user-id, calculate a hash value of P′ with the salt, and compare the result with a hash value stored for the account.

At 816, access is granted only if the purported password is verified to be the same as the actual password, e.g., hash value of the purported password agrees with the hash value stored for the account. If the security administrator 804 denies access, then the process may return to 808, where another, and different, CaRP image may be generated. Each generated CaRP image is computationally uncorrelated with another CaRP image.

The security administrator 804 may deny access after a number of failed attempts. For example, after three failed attempts, instead of repeating 808-812, the security administrator 804 may determine, at 814, to deny access.

In some embodiments, the security administrator 804 has the capability to recover a user's password P in a successful authentication procedure. However, the security administrator 804 is not required to store the user passwords. Instead, only a password indicator for a password may be recorded. Further security measures can be taken to make it hard or impossible for the security administrator 804 to recover passwords. For example, threshold cryptography can be applied so that the security administrator 804 knows only a part of a user's password and/or password indicator and other computing devices know the remainder.

However, in some embodiments, the security administrator 804 can store a password. The security administrator 804 may store a password as a sequence of password-elements, e.g., the password may be a sequence of images.

Alternatively, in some embodiments, each potential password-element in a primitive domain may be assigned a password-element identifier. The security administrator 804 may store a password as a sequence of password-element identifiers. Similarly, the security administrator 804 may store generate a password indicator based at least in part on the sequence of password-element identifiers.

### Exemplary CaRPs

TextObjs and ClassObjs are two types of CaRP Images or two CaRP schemes. TextObjs is an object-based CaRP using a primitive domain consisting of alphanumeric characters and printable symbols. ClassObjs is an object-based CaRP using a primitive domain consisting of objects in different classifications. They may employ different CAPTCHA schemes: TextObjs may employ a text CAPTCHA scheme while ClassObjs may employ an image recognition CAPTCHA scheme.

### TextObjs CaRP

In some embodiments, the primitive domain of TextObjs CaRP may consist of alphanumeric characters and printable symbols with confusing characters being removed to avoid causing any recognition errors for humans. For example, the letter “O” and numeral “0” (zero) may appear confusedly similar in a CaRP image, the numeral “1” (one) and the letter “I” may also appear confusedly similar.

A password in this case is a sequence of password-elements in the primitive domain comprising alphanumeric characters and printable symbols. Existing text CAPTCHA can be modified to generate TextObjs CaRP wherein characters (potential password-elements) in the alphabet (primitive domain) are transformed into password-element indicators and arranged randomly in two-dimension space in the CaRP image. The password-element indicators correspond to potential password-elements of the primitive domain, but the password-elements indicators are presented in a different visual representation than the potential password-elements and are yet recognizable to the user as the corresponding potential password-element.

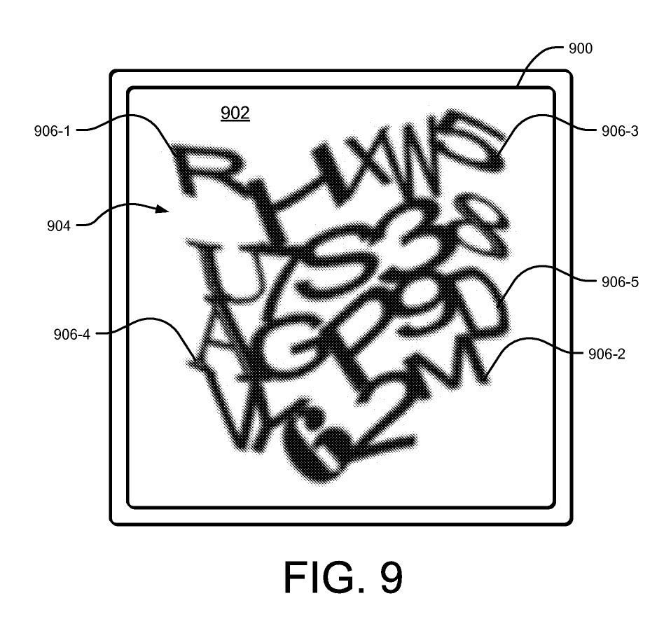

FIG. 9 is an diagram of display device 900 displaying a CaRP image 902. The CaRP image 902 has a number of password-element indicators 904 arranged in a two-dimensional pattern. The password-element indicators 904 include a number of valid password-element indicators 906-1 through 906-5 with the remainder of the password-element indicators being invalid password-element indictors. Assume a user's password is the sequence “RM5AD.” Then to correctly enter the user's password, the user must select, in the proper sequence, valid password-element indicators 906-1 through 906-5.

During generation of the CaRP image 902, the security administrator/module may track a bounding box of each password-element indicator. The resulting bounding boxes are used by the security administrator/module to identify the selected password-element indicators from the received selection-points. Small overlapping may occur between the bounding boxes of two neighboring password-element indicators. Preferably, users should not select a point very close to the boundary of a password-element indicator to avoid clicking on a fuzzy overlapping area. However, this is generally not an issue since overlapping areas make a tiny portion of a password-element indicator's bounding box.

### ClassObjs CaRP

Image recognition CAPTCHAs can also be used to build ClassObjs CaRP. The primitive domain used in ClassObjs CaRP may be several classes of objects such as sets of different types of animals, e.g., {Dog, Cat, Pig, Rabbit, . . . }. For each type of animal, one or multiple 3D models are built.

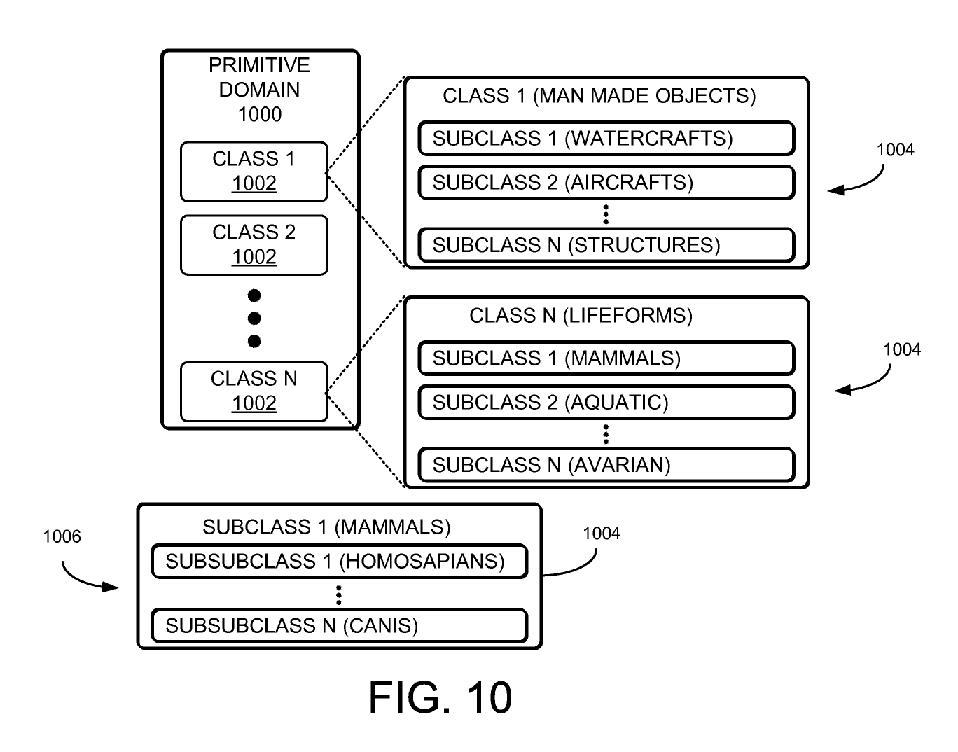

FIG. 10 shows a block diagram of a primitive domain 1000 that may be employed in a ClassObjs CaRP environment. The primitive domain 1000 includes a number of classes 1002. Each class 1002 may be comprised of a number of subclasses 1004 and subclasses 1004 may be comprised of sub-subclasses 1006. A user's password may be comprised of multiple password-elements selected from different classes, subclasses, or sub-subclasses. For example, as described below, a user's password may be comprised of a number of password-elements selected from the class “Life Forms,” subclass “Mammals.”

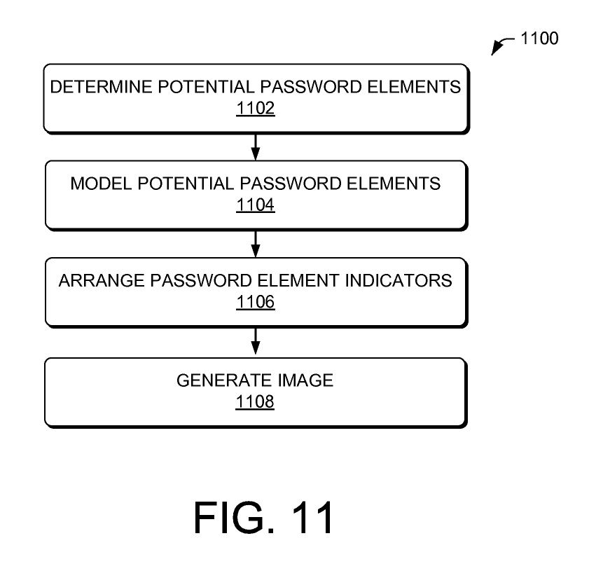

FIG. 11 is a flow diagram of a procedure 1100 for generating a ClassObjs Image.

At 1102, the number of potential password-elements, from which a ClassObjs image is generated, is determined. For example, the ClassObjs image may be generated based on four different potential password-elements such as four types of mammals, e.g., Dog, Cat, Pig, and Rabbit. The password-element indicators are randomly partitioned into contributions, at least one, from each type of the potential password-elements. For example, the number of password-element indicators may be ten, and the ten password-element indicators may be portioned into sets of three Dogs, two Cats, four Pigs, and one Rabbit. In this example, a user's password is a sequence of mammals such as P={“Cat, Dog, Cat, Dog, Pig, Dog”}.

At 1104, 3D models of the potential password-elements (e.g., Dog, Cat, Pig, Rabbit) are used to generate the number of 2D password-element indicators for each potential password-elements (e.g., 3 Dogs, 2 Cats, 4 Pigs, 1 Rabbit) by applying different views, textures, colors, lightning effects, and optional distortion.

At 1106, the resulting password-element indicators are then arranged. In some embodiments, the resulting password-element indicators are randomly arranged and/or in some embodiments randomly arranged on a cluttered background such as grassland. Some of the password-element indicators may be occluded by other password-element indicators in the CaRP ClassObjs Image, but the major features should not be occluded to avoid confusing humans in identifying each entity in the image.

At 1108, an image is generated in which the password-element indicators are arranged, randomly or in another manner, and which may include a cluttered background.

### GridClassObjs CaRP

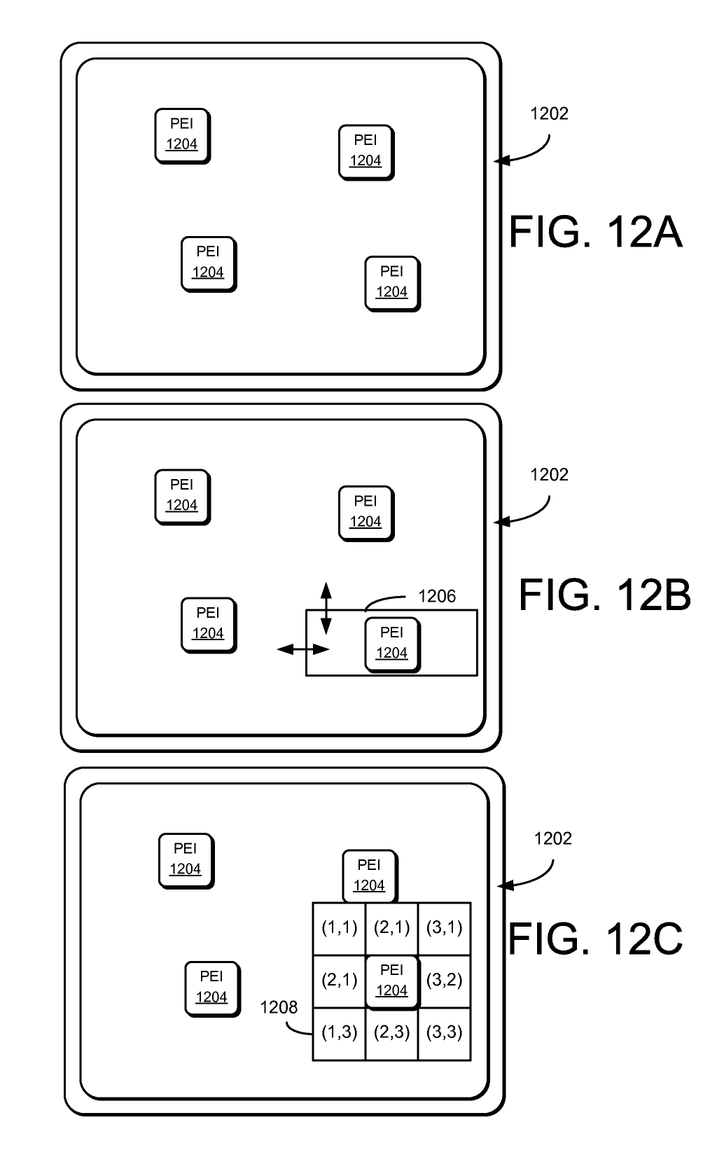

FIGS. 12A-12C are block diagrams of an illustrative display 1200 displaying GridClassObjs CaRP, which combines ClassObjs CaRP with a content-sensitive grid.

FIG. 12A shows a ClassObjs image 1202 containing a number of password-element indicators 1204. The ClassObjs image 1202 is shown in an unselected state. In this state, a user has either not yet selected one of the password-element indicators 1204 or has finished the selection of one of the password-element indicators 1204. The process of selecting password-element indicators 1204 is described below.

When the CaRP ClassObjs image 1202 is received, the user selects a password-element indicator 1204 that matches the first password-element of the user's password. For a password P=“rabbit, . . . ”, suppose there are two password-element indicators 1204 in image 1202 that are rabbits, one in pink and the other in green, the user can select a pink rabbit by selecting, via touching or clicking, a point inside it. The user can equivalently select a green rabbit by selecting, via touching or clicking, it.

Referring to FIG. 12B, a bounding rectangle 1206 for the selected password-element indicator 1204 is calculated using image processing techniques, for example Mean Shift, and displayed. Due to occlusion and the cluttering background, the calculation might be inaccurate. The user may visually verify the correctness of the displayed rectangle 1206, and may drag an inaccurate side to roughly align with a correct position if needed. Image processing techniques may then be applied to refine the moved side to align with the nearby edges. This semi-automatic correcting procedure may be repeated until the user is satisfied with the accuracy of the bounding rectangle. In most cases, the calculated bounding rectangle is accurate and there is no need to correct anything.

Referring to FIG. 12C, once the bounding rectangle 1206 of the selected password-element indicator 1204 is determined then a grid 1208 is displayed. The grid 1208 may rely on the selected password-element indicator 1204. In some embodiments, the grid size is the same as the bounding rectangle of the selected password-element indicator 1204. The grid 1208 may be approximately centered on the selected password-element indicator 1204 and may appear superimposed on the CaRP ClassObjs image 1202. The grid 1208 may also be placed at the center of the display. In the illustrated embodiment, the grid 1206 is a 3×3 grid. In other embodiments, the grid may be of different size (e.g., n×n) and may be rectangular (e.g., m×n). A user's password can be a sequence of password-elements 1204 interleaving with grid indices, e.g., in a password where password-element indicators are animals, the password may be P=“Rabbit, Grid(1,2), Grid(3, 1); Cat, Horse, Grid(2,2); Dog, . . . ”, where Grid(1,2) means the grid-square at index (1,2) and the grid indices after an animal means the grid-squares with the grid determined by the bounding rectangle of the preceding animal in the ClassObjs image 1202.

The password-element indicator 1204 inside the selected bounding rectangle 1206 is displayed as a grid-square near the center of the grid 1208. In some embodiments, the grid is displayed at the center of the display with the password-element indicator 1204 displayed at the center of the grid also moved to the center of the display. This ensures that the screen has sufficient room to display all the grids for the user to select. The user then selects a sequence of grid-squares that matches the grid indices following the selected password elements indicator 1204. For the example password, the user selects a point inside the grid-square (1, 2), and then selects a point inside the grid-square (3, 1) to ultimately select the two grid-squares. The user then returns to the password-element indicator (animal image) to select the next the password-element indicator (animal image) in the user's password. If there is no grid index following the password-element indicator (animal image) in the user's password, such as the second the password-element indicator “Cat” in the example password, the user does not select any grid-square in the n×n grid shown after a “Cat” is selected. The selected points in selecting the password-element indicator (animal image) and grid-squares form a sequence of coordinates, e.g., “PPEI(150,50),GP(30, 66),GP(89, 160), PPEI(135, 97), PPEI (82, 112), . . . ”, where “PPEI(x,y)” means the coordinates of a point on the password-element indicator (animal image), and “GP(x,y)” means the coordinates of a point on the image of n×n grid. This sequence is sent to the security administrator/module.

Upon receiving the sequence of point coordinates, the security administrator/module maps the first PEPI on the ClassObjs image 1202, and determines the selected password-element indicator, e.g., “Rabbit”. The security administrator/module then uses the bounding box of the selected password-element indicator to form a grid, and maps the following selected grid-points (GP) of grid image received on the grid image to find out the indices of the selected grid-squares, e.g., “Grid(1,2),Grid(3, 1)”. Unlike the client side, the server does not need to calculate the bounding rectangle of the selected animal. It records the bounding rectangle of each animal in the image during generating the image. This process is repeated until all the select-points in the received sequence have been mapped, e.g., “Rabbit, Grid(1,2), Grid(3, 1); Cat, Horse, Grid(2,2); Dog, . . . ”. This recovered password sequence is verified such as by then performing a hash with the salt of the account, and comparing the resultant hash value with a stored hash value.

The number of grid-squares in a grid image is typically selected to be larger than the size of the primitive domain. This leads to more choices on the grid-squares than on the primitive domain, resulting in a larger password space. GridClassObjs may use a shorter password than ClassObjs for the same level of security. This gain is at the cost of image processing at the client side and much more complex selections by users, leading to a longer time to select a password and less user-friendly.

### TextPoints CaRP

It is also possible to design a point-based fine point CaRP (FP-CaRP) scheme in which multiple selectable points inside an object can be used in a password. TextPoints is a CaRP scheme that converts TextObjs to a FP-CaRP scheme. It should be noted that ClassObjs can also be similarly extended to a FP-CaRP scheme. In some embodiments, salient structural points in an object may be used as selective points. For example, TextPoints may use cross-points in a character as selectable points. Salient structural points seem to help in the following ways as compared to other points in an image:
1. Long memory of the points in a FP-CaRP password with less recalling errors; and
2. Higher accuracy in repeatedly selecting the same point.

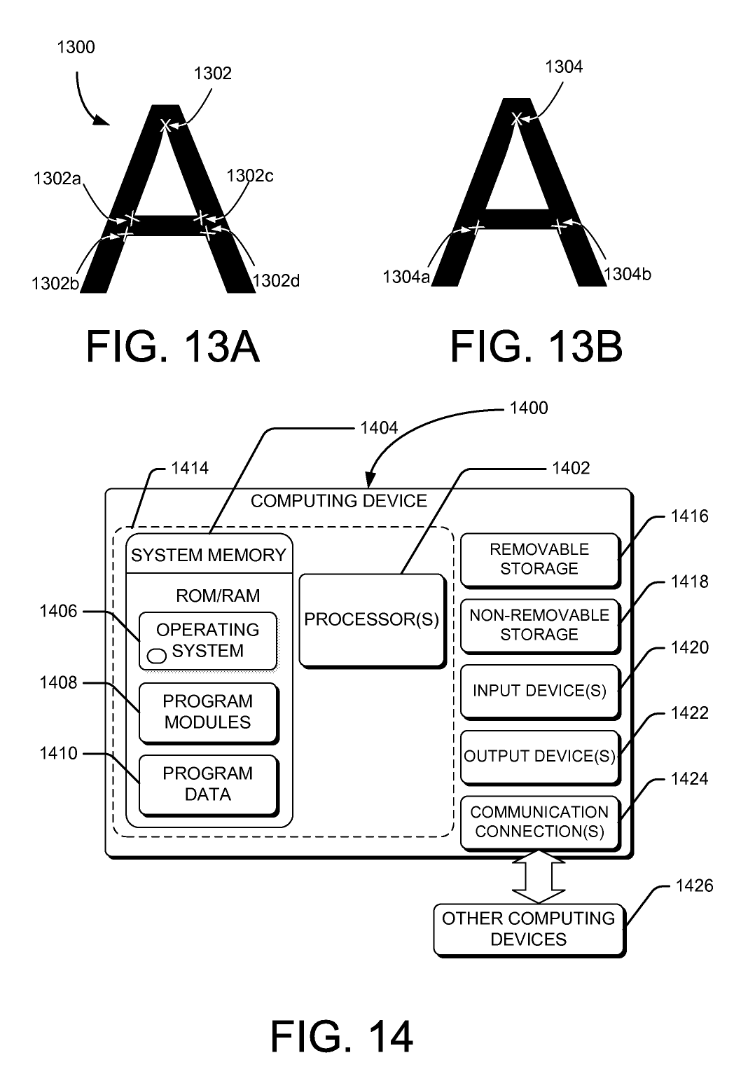

FIGS. 13A and 13B are diagrams of illustrative potential password elements of TextPoints, a point-based fine point CaRP (FP-CaRP) based on characters.

In one embodiment, only cross-points in a character are allowed as selectable points in a password. Referring to FIG. 13A, an illustrative potential password element 1300 is shown. A cross-point in a character is the point that two or more strokes intersect. For example, the five cross points (X) 1302 in FIG. 13A are cross-points of the letter “A”. These cross-points are much easier to remember and to accurately locate than other points in “A”.

Different fonts can be used to generate a CaRP image. For example, “A” of font Times New Roman can be used in one CaRP image while “A” of font Arial can be used in another CaRP image. A user has to select the same point inside “A” no matter what allowed font is used. This means that in some embodiments the only allowed points are invariant for different allowed fonts. The five cross points shown in FIG. 13A are invariant points. In addition, points along the outside contour of a character are not used since those points might be occluded or inside the area overlapping with the neighboring character.

The primitive domain of TextPoints may consist of internal and invariant cross-points of the character set used to generate TextPoints images. The five cross points (X) 1302 shown in FIG. 13A meet the requirements. But the points 1302a and 1302b, and similarly the points 1302c and 1302d, are very close. For some allowed fonts of “A”, these two points might be within the allowed select error that it is hard to tell what the user's intention is. Therefore, the distance of any two points in the primitive domain belonging to the same character must be larger than a preset threshold. A possible selection of the primitive domain for letter “A” is the three cross points (X) 1304, 1304a, and 1304b shown in FIG. 13B. Characters without any internal cross-point, e.g., letter “S”, do not contribute any points to the primitive domain of TextPoints. These characters can still be used in generating CaRP images. They are cluttering characters to confuse computers.

It is worth comparing potential password points between TextPoints and existing select-based fine granularity graphical passwords such as PassPoints. In PassPoints, salient structural points should be avoided since they are readily picked up by an adversary to mount a dictionary attack. Avoiding these structural points makes it hard for humans to remember the points in a password for a long time. These conflicting requirements have forced existing select-based fine granularity graphical passwords to strike a tradeoff between security and usability. TextPoints addresses this problem by removing the conflict. In TextPoints, structural points are used to help remember the points selected in a password. They are dynamic (as compared to static points in existing graphical password systems) and contextual:
1. Dynamic: The locations of the points in the primitive domain as well as their contexts (i.e., characters) vary from one image to another. The points in one image are computationally uncorrelated to the points in another image.
2. Contextual: Whether a similarly structural point is in the primitive domain (thus a candidate point of passwords) or not depends on its context. It is only if within the right context, i.e., at the right location of the character it belongs to.

This context-dependence requires an adversary to recognize the correct contexts, i.e., characters, first. If this task can be accomplished, the underlying CAPTCHA is broken: the characters in a CaRP image are recognized by computers since the image is actually a CAPTCHA challenge.

In generating a CaRP image, the server checks the locations of the points in the primitive domain to make sure that no point is occluded or too close to another character. Upon receiving a CaRP image, a user identifies the characters in the image and selects her password points on the right characters. A sequence of the coordinates of the selected points is sent to the authentication server. Upon receiving the sequence, the server maps the coordinates on the image it sent to the client, and finds out the closest password candidate points for each selected point and the error distance. If an error distance larger than a preset error tolerance is detected, access is denied. Otherwise the sequence of password candidate points is recovered from the received selected points. Its hash value is calculated with the salt of the account and compared with the stored hash value to decide if access is granted or not.

### Variations and Discussion

CaRP schemes working with the HTTP Basic Access Authentication that employs the transport layer security HTTPS to secure the communications between the Web server and a client during a user authentication have been described above. However, the HTTP standards also support the HTTP Signature Access Authentication, which is a challenge-response authentication protocol. This protocol is rarely used in practice since it still needs HTTPS to provide secure communications between the client and the server. Nevertheless, a CaRP scheme, called TextPoints for Challenge-Response (TextPoints4CR) CaRP is described below.

A CaRP image is a CAPTCHA image. Visual objects in a CaRP image are typically warped or deliberately distorted to prevent computers from recognizing them. In other words, password-element indicators are typically warped or distorted versions of potential password elements. This may have adverse impact on user experiences since humans may need a longer time in recognizing the visual objects in a CaRP image than the case when the visual objects are not warped or distorted. It is possible to combine CaRP with a soft “keyboard” or other ways to enter a password (e.g., typing a password with a keyboard when characters are used): at one time a CaRP image is used, and another time a soft “keyboard” is used. A soft “keyboard” is an image which displays potential password elements. Potential password elements are easier for humans to identify than password-element indicators since password-element indicators are typically a warped version of potential password elements. In some embodiments, different incarnations of a potential password element may be used in different soft “keyboard” instances or images. For example, at one instance of a soft “keyboard”, letter “A” appears as Times New Roman font. In another instance of a soft “keyboard”, letter “A” appears as Arial font. In one embodiment, the potential password elements in a soft “keyboard” are arranged in a random order. In another embodiment, the potential password elements in a soft “keyboard” are arranged in a preset order. For a CaRP using characters as potential password elements, the soft “keyboard” is a conventional soft keyboard. For a CaRP using animals as potential password elements, a soft “keyboard” may be an image containing different animals.

Different mechanisms can be applied to determine when a CaRP is used and when a soft “keyboard” is used. In some embodiments, a decision mechanism similar to that used in CAPTCHA-based Password Authentication (CPA) protocols can be applied: when CPA decides a CAPTCHA image should be used, a CaRP image is used; and when CPA decides a CAPTCHA image should not be used, a soft “keyboard” is used.

In one embodiment, a CaRP image is used when an unknown device such as a user device 104a or 104b in FIG. 1 or a computing system 202 in FIG. 2 or portable user device 302 in FIG. 3 is used, and a soft keyboard is used when a known device is used. A device is known if the user has a successful login within a fixed period of time. In some embodiments, a device has also to be a trusted device to be a known device. In one embodiment, a known device may be identified by its IP address or device ID stored with the user ID in a user profile database 108 in FIG. 1 or user profilers 219 or 314 in FIGS. 2 and 3. In another embodiment, a known device may be identified by a cookie stored on the device. A CaRP image may be used when a user fails in a number of login attempts with a known device.

In another embodiment, soft “keyboard” is used unless a user has failed in a number of login attempts, and then a CaRP image is used. Different thresholds of failed login attempts may be applied, depending on if the device is known or unknown. A small threshold of failed login attempts (e.g., 3) may be applied when a device is unknown and a large threshold of failed login attempts (e.g., 30) may be applied when a device is known.

In some embodiments, another way to enter a password other than using a soft “keyboard” is used with CaRP images. For example, when characters are used, the soft “keyboard” is replaced with a real keyboard that a user enters her password by typing on the real keyboard.

### TextPoints4CR CaRP

TextPoints4CR is a CaRP modified from the TextPoints for a general challenge-response user authentication. Unlike TextPoints wherein the authentication server stores a salt and the hash value of the password and the salt along with the userID, the authentication server in TextPoints4CR stores the password and userID. Another difference between these two CaRPs is that a TextPoints4CR image does not contain any repeated characters while a character in a TextPoints image can be repeated. This is because that TextPoints4CR requires both the server and the client to generate an identical sequence of discretized grids without exchanging any information about the sequence. Therefore there must be a unique way to generate this sequence from the shared secret, i.e., password. If there are repeated characters which contains the points used in the password, generation of this sequence is no longer unique. This sequence is used as if the secret in a conventional challenge-response authentication protocol.

Suppose the tolerant select error along both x-axis and y-axis is t, and the discretization grid size is u≧4τ on both directions. To generate a TextPoints4CR image, the same procedure to generate a TextPoints image is first applied. Then all the points in the primitive domain are located on the image, overlaid with the discretization grid. For every point in the primitive domain, the distance to the center of the discretization grid-square it is in along both x-axis and y-axis is calculated. A point is said to be an internal point if the distance is less than 0.5μ-τ on both directions; otherwise a boundary point. For each boundary point, a nearby internal point in the same discretization grid-square is randomly selected. This selected point is said to be the point associated with the boundary point. Once having processed all the points in the primitive domain, a warping operation is applied on the image to move all the boundary points in the primitive domain to their associated points while all the internal points in the primitive domain stay at the same location. On the resulting image, all the points in the primitive domain are internal points, each at least τ distance away from the boundary of its discretization grid-square. The image is then sent to the client to select her password. If the user's select error is within τ, then each selected point falls into the same discretization grid-square as the original password point. Therefore identical sequences of discretized grid-squares are generated: the authentication server generates the sequence from the stored password retrieved after the userID is received, and the client generates the sequence from the user selects. These two identical sequences are then used as if a conventional secret shared between the two parties in challenge-response authentication.

Unlike other proposed CaRP schemes, TextPoints4CR requires the authentication server to generate the same sequence of discretized grid-squares as a user correctly selects during a user authentication without relying on any information from the client. Storage of passwords at an authentication server might be a security concern since an inside attacker might be able to steal. To mitigate this problem, user passwords should be encrypted by a master key that only the authentication server knows. During a user authentication, the encrypted password is retrieved using the received userID, decrypted, and then used to generate the sequence of discretized grid-squares. The decrypted password is then deleted from memory.

### Illustrative Computing Device

FIG. 14 shows an illustrative computing device 1400 that may be used to implement the security administrator 102 and/or the security module 214/310. It will readily be appreciated that the various embodiments described above may be implemented in other computing devices, systems, and environments. The computing device 1400 shown in FIG. 14 is only one example of a computing device and is not intended to suggest any limitation as to the scope of use or functionality of the computer and network architectures. The computing device 1400 is not intended to be interpreted as having any dependency or requirement relating to any one or combination of components illustrated in the example computing device.

In a very basic configuration, the computing device 1400 typically includes at least one processing unit (or processor) 1402 and system memory 1404. Depending on the exact configuration and type of computing device, the system memory 1404 may be volatile (such as RAM), non-volatile (such as ROM, flash memory, etc.) or some combination of the two. The system memory 1404 typically includes an operating system 1406, one or more program modules 1408, and may include program data 1410. The computing device 1400 is of a very basic configuration demarcated by a dashed line 1414.

The computing device 1400 may have additional features or functionality. For example, the computing device 1400 may also include additional data storage devices (removable and/or non-removable) such as, for example, magnetic disks, optical disks, or tape. Such additional storage is illustrated in FIG. 14 by removable storage 1416 and non-removable storage 1418. Computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. The system memory 1404, the removable storage 1416 and the non-removable storage 1418 are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other non-transmission medium that can be used to store the desired information and which can be accessed by the computing device 1400. Any such computer storage media may be part of the computing device 1400. Moreover, the computer-readable media may include computer-executable instructions that, when executed by the processor(s) 1402, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media.

The computing device 1400 may also have input device(s) 1420 such as keyboard, mouse, pen, voice input device, touch input device, etc. Output device(s) 1422 such as a display, touch sensitive display, speakers, printer, etc. may also be included. These devices are well known in the art and are not discussed at length here.

The computing device 1400 may also contain communication connections 1424 that allow the device to communicate with other computing devices 1426, such as over a network. These networks may include wired networks as well as wireless networks. The communication connections 1424 are one example of communication media.

It is appreciated that the illustrated computing device 1400 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

### CONCLUSION

Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A method of providing a password system to a computing device, in which a password comprises a sequence of potential password-elements or selectable points inside one or a plurality of visual objects, the method comprising:
generating an image comprising a plurality of regions, each region of the plurality of regions having a password-element indicator therein such that there are a plurality of password-element indicators in the image, each password-element indicator corresponds to a potential password-element;
providing the image for display to the user; and
determining whether a user-input entered by the user corresponds to a password based at least on knowledge of the plurality of password-element indicators and the corresponding regions, the user-input indicating user selection of one or plurality of password-element indicators or points inside password-element indicators the user has recognized.

2. The method of claim 1, further comprising:
receiving a user-identifier indicative of an identity of the user, and wherein the generating an image comprises generating the image based at least on the user-identifier.

3. The method of claim 2, wherein the plurality of password-element indicators is a subset of a second, larger, plurality of potential password-elements, and wherein the generating an image further comprises:
selecting or determining the plurality of potential password-elements from the second, larger, plurality of password-elements based at least partially on the user-identifier;
generating a plurality of password-element indicators corresponding to the selected plurality of potential password-elements.

4. The method of claim 1, wherein the image is a challenge image that identifies password-element indicators and associates valid password-element indicators with their corresponding potential password elements can be easily performed by humans but beyond capability of automatic machines.

5. The method of claim 4, wherein the generating a challenge image further comprises:
determining a plurality of potential password-elements from a primitive domain or a sub-primitive-domain;
transforming each of the plurality of the selected potential password-elements into a corresponding one of the password-element indicators, wherein each password-element has a first displayable shape and the corresponding password-element indicator has a second displayable shape that may be different from the first displayable shape;
assigning each of the password-element indicators with a region of the plurality of regions such that each region of the plurality of regions has mainly only one password-element indicator associated therewith.

6. The method of claim 5, wherein the generating a challenge image further comprises:
applying operations, joint or independent, to the image after each of the password-element indicators has been placed at their respective assigned regions, in order to make the image and also the password-element indicators into different shapes.

7. The method of claim 5, wherein the transforming further comprising:
selecting an incarnation for each of the plurality of the selected potential password-elements; and
applying operations, joint or independent, to each incarnation of a potential password-element to produce a different displayable shape.

8. The method of claim 1, wherein determining whether a user-input entered by the user corresponds to a password further comprising:
receiving a user-input comprising of a sequence of coordinates of selected points;
mapping the received coordinates on the generated image to recover a sequence of potential password-elements or selectable points inside potential password-elements;
generating a password indicator from the recovered sequence; and
comparing with the stored password indicator for the user.

9. The method of claim 1, further comprising:
determining none, one, or a plurality of selectable points for each visual object of a plurality of visual objects that are used to generate the image;
generating the image;
checking each selectable point in the resultant image, and identifying those selectable points within a preset threshold distance to a boundary of its visual object;
applying operations on the resultant image to map each identified selectable point to a point inside the same visual object but with a distance to any part of the boundary of the visual object is large than the preset threshold distance;
receiving information generated by a client device, the information based at least partially on a sequence of the grid points in which the client device maps user input to the sequence of grid points;
retrieving the password and mapping the password on the generated image to produce a sequence of selectable points; and
determining if the received information agrees with that generated by the sequence of selectable points from the actual password.

10. One or more computer-readable media storing computer-executable instructions that, when executed on one or more processors, causes the one or more processors to perform acts comprising:
generating a random image comprising a plurality of regions, each region of the plurality of regions having a password-element indicator therein such that there are a plurality of password-element indicators in the random image;
providing the image for display to the user; and
determining whether a user-input entered by the user corresponds to a password based at least on knowledge of the plurality of password-element indicators and the corresponding regions.

11. The one or more computer-readable media as recited in claim 10, wherein the instructions that, when executed on one or more processors, causes the one or more processors to perform further acts comprising:
in response to determining that the user-input entered by the user did not correspond to the password,
generating a second random image comprising a plurality of regions, each region of the plurality of regions having a password-element indicator therein such that there are a plurality of password-element indicators in the second random image,
providing the second image for display to the user, and
determining whether a second user-input entered by the user corresponds to the password based at least on knowledge of the plurality of password-element indicators and the corresponding regions of the second image.

12. The one or more computer-readable media as recited in claim 10, wherein the instructions that, when executed on one or more processors, causes the one or more processors to perform further acts comprising:
receiving a user-identifier indicative of an identity of the user, and wherein the generating a random image comprises generating the random image based at least on the user-identifier.

13. The one or more computer-readable media as recited in claim 12, wherein the plurality of password-element indicators is a subset of a second, larger, plurality of password-elements, and wherein the act of generating a random image further comprises:
selecting the plurality of password-element indicators from the second, larger, plurality of password-elements based at least on the user-identifier.

14. The one or more computer-readable media as recited in claim 10, wherein the instructions that, when executed on one or more processors, causes the one or more processors to perform further acts comprising:
retrieving the password of the user, the password comprising a number of password-elements, wherein each password-element of the number of password-elements corresponds to one valid password-element indicator of the plurality of password-element indicators;
retrieving the corresponding password-element for each password-element of the number of password-elements;
retrieving at least one password-element that does not correspond to any password-element of the number of password-elements; and
randomly assigning each of the password-element indicators with a region of the plurality of regions such that each region of the plurality of regions has only one password-element indicators associated therewith, each password-element indicator corresponding to one of the retrieved password-elements.

15. The one or more computer-readable media as recited in claim 14, wherein the instructions that, when executed on one or more processors, causes the one or more processors to perform further acts comprising:
transforming each of the retrieved password-elements into a corresponding one of the password-element indicators, wherein each password-element has a first displayable shape and the corresponding password-element indicator has a second displayable shape that is different from the first displayable shape.

16. The one or more computer-readable media as recited in claim 10, wherein the instructions that, when executed on one or more processors, causes the one or more processors to perform further acts comprising:
receiving a user-identifier indicative of an identity of the user, and wherein the generating a random image comprises generating the random image independent of the user-identifier.

17. The one or more computer-readable media as recited in claim 16, wherein the act of generating a random image further comprises randomly assigning at least one valid password-element indicator and at least one invalid password-element indicator into a previously unassigned region of the plurality of regions.

18. A computing device, comprising:
at least one processing unit; and
at least one computer readable medium in communication with the at least one calculating unit and having instructions that when executed by the at least one processing unit, cause the at least one processing unit to perform acts comprising:
generating a first random image comprising a plurality of regions, each region of the plurality of regions having a password-element indicator therein such that there are a plurality of password-element indicators in the random image, the plurality of password-element indicators including at least one valid password-element indicator known to a user and at least one invalid password-element indicator;
providing the image for display to the user; and
determining whether a user-input entered by the user corresponds to a password based at least on knowledge of the plurality of password-element indicators and the corresponding regions, the user-input indicating user selection of at least one of at least one valid password-element indicator or at least one invalid password-element indicator; and
in response to determining that the user-input entered by the user did not correspond to the password, generating a second random image comprising a plurality of regions, each region of the plurality of regions having a password-element indicator therein such that there are a plurality of password-element indicators in the random image, the plurality of password-element indicators including the at least one valid password-element indicator known to a user and the at least one invalid password-element indicator, the second random image being visually different from the first random image.

19. The computing device of claim 18, further comprising:
a touch screen that displays the image and that receives the user-input.

20. The computing device of claim 18, wherein the instructions that, when executed by the at least one processing unit, cause the at least one processing unit to perform further acts comprising:
in response to determining that the user-input entered by the user did not correspond to the password,
providing the second image for display to the user, and determining whether a second user-input entered by the user corresponds to the password based at least on knowledge of the plurality of password-element indicators and the corresponding regions of the second image, the second user-input indicating user selection of at least one of at least one valid password-element indicator or at least one invalid password-element indicator.
